(19) United States
(12) Patent Application Publication
(10) Pub. No.: US 2010/0015870 A1
(43) Pub. Date: Jan. 21, 2010

(54) Printed fabric and a manufacturing process thereof

(76) Inventor: Chien-Hung Lin, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/219,256

(22) Filed: Jul. 18, 2008

(51) Int. Cl. B32B 5/02; C09K 11/02

(52) U.S. Cl. 442/59; 156/67

(57) ABSTRACT

A manufacturing process for a printed fabric includes the following steps. A substrate layer and a fabric are provided and the fabric is pasted onto the substrate layer. The substrate layer and the fabric are sent to the printer to perform a UV printing. Thereby, the UV ink printed on the fabric can be suddenly dried to prevent the UV ink from expanding. Therefore, the figures on the printed fabric can be more dedicate, beautiful and clear. The printed fabric can be mass produced by machine to reduce the cost and the manufacturing time. A printed fabric is also provided.

### BACKGROUND OF THE INVENTION

1. Field of the Invention

The present invention relates to a printed fabric and a manufacturing process thereof. In particular, this invention relates to a printed fabric and a manufacturing process thereof that is implemented by a printing method.

2. Description of the Related Art

The method of printing fabric of the prior art is implemented by screen printing (such a decorative pattern on a fabric), big figure outputting (such as a fabric flag on the road or a poster), or heat transfer printing (such as figures on fabric), etc. Thereby, the figures and the text are attached on the fabric. The screen printing is to directly scraping the printing ink onto the fabric via a screen to color the fabric. Because fabric can shrink after being wet, the printing ink exaggerates due to the capillarity. The color will not be easily processed on the fabric. The figures and the text on the fabric will be blurred. Furthermore, the quality of the screen printing also is affected by the worker's experience and the climate. Screen printing uses a color block as a unit. The layered appearance of complex figures cannot be printed by a single screen. Therefore, a plurality of screens is required to show the layered appearance of the figure. The cost is high.

In order to emphasize the printing effect, a digital printing method, such as the big figure outputting, is used for printing the poster. The big figure outputting is implemented by a large-scale inkjet printer. Although the big figure outputting can make the printed fabric more beautiful, the printing process is time-consuming, and the format of the figure file for the big figure outputting is limited to a specific one. The printing quantity is little. For printed fabrics with a great amount of quantity, such as books, posters, or calendars, the cost also is high.

Heat transfer printing uses sublimated ink to print a figure on the fabric. The molecule structure of the sublimated ink is transferred from the liquid state to the gaseous state (sublimation) by heating. However, the heat transfer printing is implanted at 160˜200□. Therefore, the heat transfer printing usually is applied to ceramics, metal, or artificial fiber fabric. Moreover, because the fabric will shrink under high temperature, the figures printed by heat transfer printing easily chap, or lose the color. The figures cannot be mass produced by the heat transfer printing.

### SUMMARY OF THE INVENTION

One particular aspect of the present invention is to provide a printed fabric and a manufacturing process thereof. The printed fabric is delicate and beautiful, and can be mass produced by machine to reduce the cost and the manufacturing time.

The manufacturing process for a printed fabric includes the following steps.

A substrate layer and a fabric are provided. One surface of the substrate layer is coated with a glue layer, and the fabric is pasted on the substrate layer via the glue layer.

The substrate layer and the fabric are cut into the dimension of the printed fabric, and the substrate layer and the fabric are smoothly pressed.

A printed figure is provided, and the three original colors (RGB) of the figure are converted into four colors (CMKY) for printing.

A plurality of printing plates for the four colors are respectively produced, and the plurality of printing plates are installed in an ink trough of a printer.

The substrate layer and the fabric are sent to the printer to perform a UV printing to suddenly dry the UV ink printed on the fabric.

Finally, the substrate layer and the fabric are processed by an offspring process to be a printed fabric.

The present invention also provides a printed fabric. The printed fabric includes a substrate layer, and a fabric. One surface of the substrate layer is coated with a glue layer. One surface of the fabric is printed with a UV ink layer. Another surface of the fabric is pasted onto the substrate layer via the glue layer. The glue layer is combined between the fabric and the substrate layer.

The present invention has the following characteristics. The printed fabric of the present invention uses the substrate layer and the fabric to perform the UV printing. Because the UV light has a characteristic of being high power and the UV ink can be suddenly dried, the UV ink printed on the fabric can be suddenly dried to prevent the UV ink from expanding due to the capillarity. Therefore, the figures on the printed fabric can be more dedicate, beautiful and clear. The printed fabric can be mass produced by machine to reduce the cost and the manufacturing time.

For further understanding of the invention, reference is made to the following detailed description illustrating the embodiments and examples of the invention. The description is for illustrative purpose only and is not intended to limit the scope of the claim.

### BRIEF DESCRIPTION OF THE DRAWINGS

The drawings included herein provide a further understanding of the invention. A brief introduction of the drawings is as follows:

FIG. 1 is a flow chart of the manufacturing process for a printed fabric of the present invention;

FIG. 2 is a schematic diagram of the substrate layer being combined with the fabric in the manufacturing process for a printed fabric of the present invention;

FIG. 3 is a perspective view of the printer for the manufacturing process for a printed fabric of the present invention;

FIG. 4 is a schematic diagram of the printer for the manufacturing process for a printed fabric of the present invention;

FIG. 5 is an exploded perspective view of the printed fabric of the present invention; and

FIG. 6 is a cross-sectional view of the printed fabric of the present invention.

### DETAILED DESCRIPTION OF THE PREFERRED EMBODIMENTS

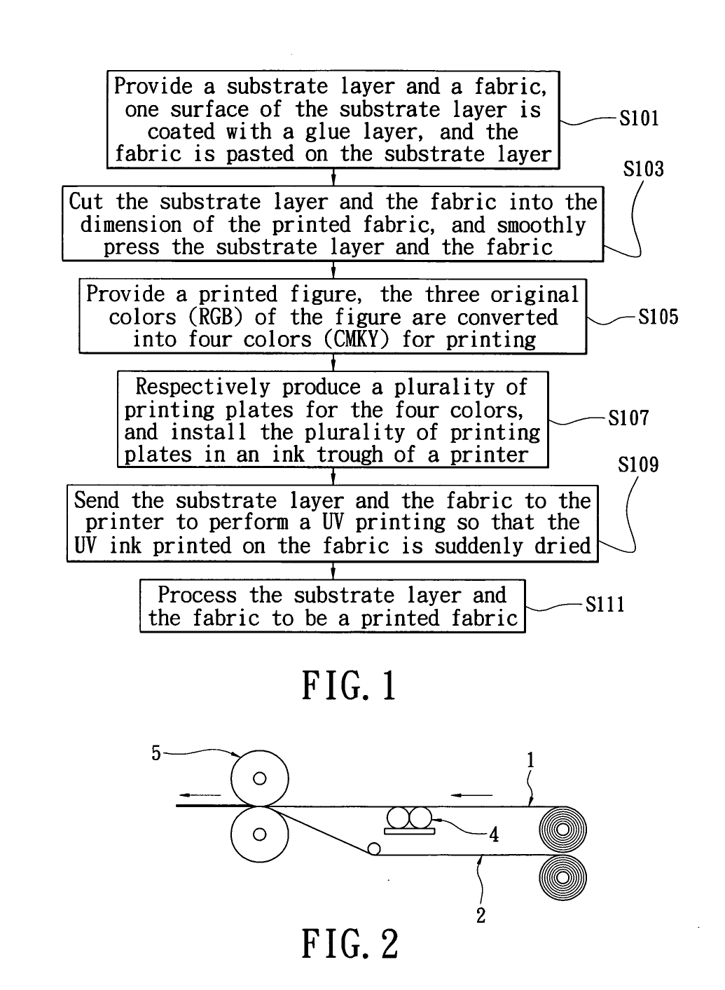

Reference is made to FIGS. 1˜4, which show the manufacturing process for a printed fabric of the present invention. The manufacturing process for a printed fabric includes the following steps.

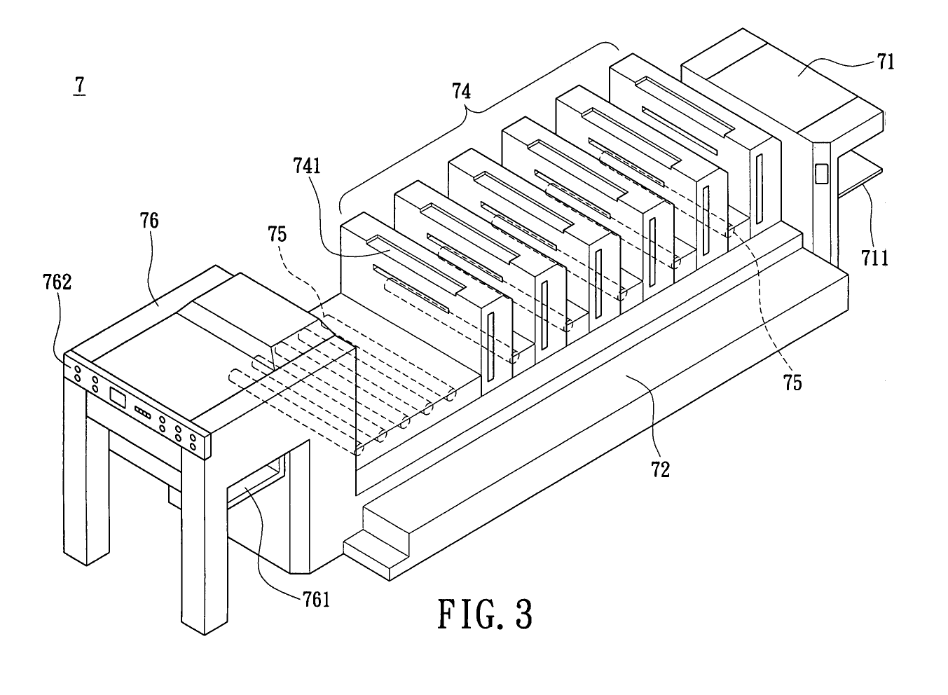

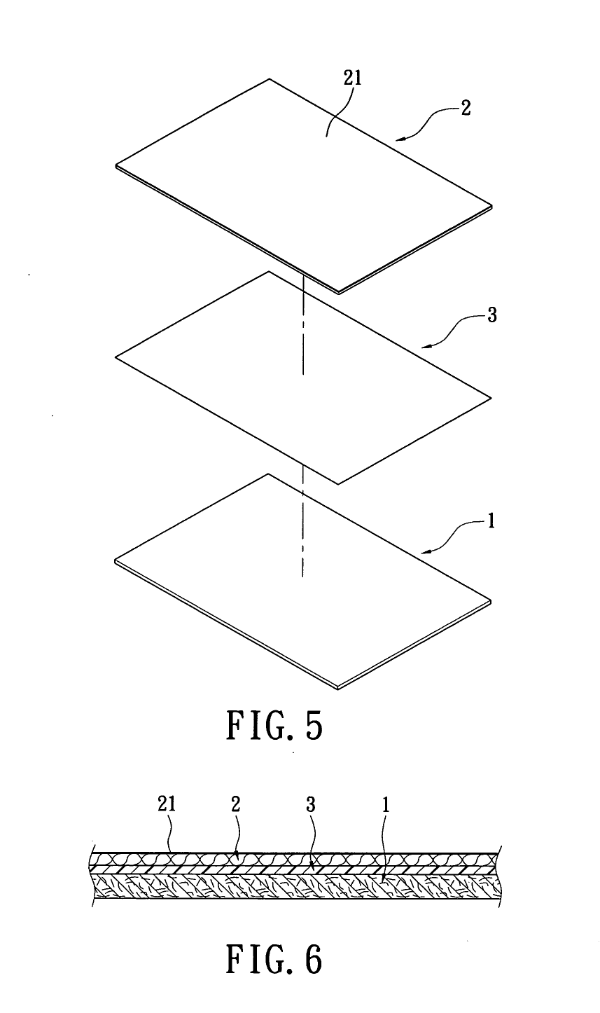

A substrate layer 1 and a fabric 2 are provided (S101). Part of the substrate layer 1 and the fabric 2 are rolled and received on a roller. A gluing machine 4 (as shown in FIG. 2) is used for coating a glue layer 3 on one surface of the substrate layer 1 (as shown in FIG. 5). The thickness of the glue layer 3 is 0.015 mm. The fabric 2 and the substrate layer 1 are pressed by two rolling wheels 5 to be pasted together. The pressure is 300 KG per square inch. Thereby, the glue layer 3 is combined between the substrate layer 1 and the fabric 2.

The substrate layer 1 is made of paper or plastic. The fabric 2 is natural silk fabric, flannelette, or other fabrics. When the substrate layer 1 is made of paper, the glue layer 3 is a water glue. When the substrate layer 1 is made of plastic, the glue layer 3 is an organic glue. The thickness of the substrate layer depends on the requirement to provides an adequate supporting force fort the fabric 2 to prevent the fabric 2 from be shrunk due to be wet.

The substrate layer 1 and the fabric 2 are cut into the dimension of the printed fabric, such as a standard-sized sheet, a semi standard-sized sheet or a quarter standard-sized sheet (S103). Next, the substrate layer 1 and the fabric 2 are smoothly pressed by a hydraulic press (not shown in the figure). When the quantity of the printed fabric is little, the substrate layer 1 and the fabric 2 are smoothly pressed by manpower.

A printed figure (not shown in the figure) is provided (S105). By using a computer or other digital electronic equipment, the three original colors (RGB) of the figure are converted into four colors (CMKY) for printing.

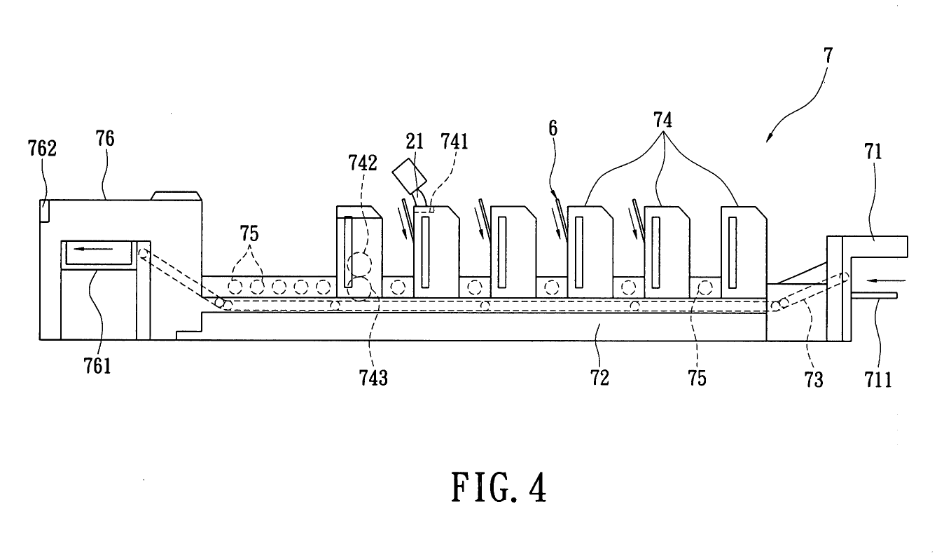

A plate making machine (not shown in the figure) is used for manufacturing a plurality of printing plates 6 for the four colors. In this embodiment, the quantity of the printing plates 6 is four. Next, the plurality of printing plates 6 are respectively plugged at one side of the printer 7 (as shown in FIG. 4), and the printing plates 6 will be rolled in an ink trough 74 of the printer 7.

The chemicals are coating on an aluminum plate and correspond to the four colors (CMKY) for printing to be exposed to be manufactured as a pre-costing and sensing plate (PS plate).

The printer 7 is a six-color printer and can perform the digital printing. The printer 7 includes an input terminal 71. The input terminal 71 has a hoister 711 for placing the substrate layer 1 and the fabric 2. The input terminal 71 is connected with a base 72. The interior of the base 72 has a transmitting machine 73 for transmitting the substrate layer 1 and the fabric 2 to another side of the printer 7 via the input terminal 71. The top of the base 72 has six ink troughs 74. The top of each of the ink troughs 74 has an opening 741 for adding the UV ink 21. The interior of the ink trough 74 has an ink roller 742 and a rubber roller 743. The rubber roller 743 is located below the ink roller 742 and above the transmitting machine 73. The rubber roller 743 is flexible and can enhance the effect of transferring printing. A UV lamp 75 (As shown in FIG. 4) is located in the interior of the base 72 and respectively is located between the ink troughs 74. The UV lamps are located above the transmitting machine 73 for shining the UV ink 21 printed on the fabric 2 and drying the UV ink 21 as the first time. Another side of the base 72 that is opposite to the input terminal 71 is connected with an output terminal 76. The output terminal 76 has a hoister 761 and a control panel 762. The hoister 761 is used for carrying the substrate layer 1 and the fabric 2 outputted from the transmitting machine 73. The control panel 762 is used for setting the printer 7, such as the quantity of the printing lines (the dot per inch) and the printing pressure. There are five UV lamps 75 located in the base 72 and located between the ink troughs 74 and the output terminal 76 for shining the UV ink 21 printed on the fabric 2 and drying the UV ink 21 for the second time.

The substrate layer 1 and the fabric 2 are sent to the printer 7 to perform a UV printing so that the UV ink 21 printed on the fabric are suddenly dried (S109).

The UV printing is implemented by using principle of the lithographic printing. The principle is the water being repelled with the ink. Due to the chemicals, the figure on the printing plate 6 has the characteristic of absorbing ink and repelling the water, and area of the printing plate 6 without the figure has the characteristic of absorbing water and repelling the ink. Therefore, firstly, the printing plate 6 passes through water. The ink roller 742 coats the UV ink 21 on the printing plate 6. The printing plate 6 transfers and prints the figure on the rubber roller 743. Next, the rubber roller 743 prints the figure on the fabric 2 transmitted by the transmitting machine 73. Finally, the UV lamps 75 shine the UV ink 21 to suddenly dry the UV ink 21.

Finally, the substrate layer 1 and the fabric 2 are processed (such as mounting, pasting, and cutting) to be a printed fabric (S111). When the substrate layer 1 is made of paper, the printed fabric is a cover of book, a magazine, a bag, an envelope, a paper clipper, a card clipper, a box, a name card, a desk calendar, a year/month calendar, a poster or a menu, etc.

By using the above manufacturing process for a printed fabric, the printed fabric (as shown in FIGS. 5 and 6) is developed. The printed fabric includes the substrate layer 1, the fabric 2, the glue layer 3 and the UV ink 21 etc, and the structure is not repeated again.

The present invention sends the substrate layer 1 and the fabric 2 to the printer 7 to perform the UV printing. Because the UV light has a characteristic of being high power and the UV ink 21 can be suddenly dried, the UV ink 21 printed on the fabric 2 can be suddenly dried by the UV lamps 75 to prevent the UV ink 21 from expanding due to the capillarity of the fabric 2. Therefore, the figures on the printed fabric can be more dedicate, beautiful and clear. The printed fabric can be mass produced by the printer 7 to reduce the cost and the manufacturing time.

The description above only illustrates specific embodiments and examples of the invention. The invention should therefore cover various modifications and variations made to the herein-described structure and operations of the invention, provided they fall within the scope of the invention as defined in the following appended claims.

What is claimed is:

1. A manufacturing process for printed fabric, comprising:
providing a substrate layer and a fabric, wherein one surface of the substrate layer is coated with a glue layer, and the fabric is pasted onto the substrate layer via the glue layer so that the glue layer is combined between the substrate layer and the fabric;
cutting the substrate layer and the fabric into the dimension of the printed fabric, and smoothly pressing the substrate layer and the fabric;
providing a printed figure, wherein three original colors (RGB) of the figure are converted into four colors (CMKY) for printing;
respectively producing a plurality of printing plates for the four colors, and installing the plurality of printing plates in an ink trough of a printer;
sending the substrate layer and the fabric to the printer to perform a UV printing so that the UV ink printed on the fabric is suddenly dried; and
processing the substrate layer and the fabric to be a printed fabric.

2. The manufacturing process for printed fabric as claimed in claim 1, wherein in the step of the fabric being pasted on the substrate layer, a gluing machine applies the glue layer on one surface of the substrate layer, and the fabric and the substrate layer is pressed by a roller.

3. The manufacturing process for a printed fabric as claimed in claim 1, wherein in the step of respectively producing a plurality of printing plates for the four colors, chemicals are coated on an aluminum plate and then is exposed to be a pre-coating and sensing plate (PS plate).

4. The manufacturing process for a printed fabric as claimed in claim 1, wherein the UV printing uses the principle of the lithographic printing, the print plate passes through water, the UV ink is coated on the printing plate, the printing plate prints the figure on a rubber roller, the rubber roller prints the figure on the fabric, and the UV lamp shines the UV ink and dries the UV ink.

5. A printed fabric, comprising:
a substrate layer, wherein one surface of the substrate layer is coated with a glue layer;
a fabric, wherein one surface of the fabric is printed with a UV ink layer, another surface of the fabric is pasted onto the substrate layer via the glue layer, and the glue layer is combined between the fabric and the substrate layer.

6. The printed fabric as claimed in claim 5, wherein the substrate layer is made of paper, and the glue layer is a water glue.

7. The printed fabric as claimed in claim 6, wherein the printed fabric is a cover of book, a magazine, a bag, an envelope, a paper clipper, a card clipper, a box, a name card, a desk calendar, a year/month calendar, a poster or a menu.

8. The printed fabric as claimed in claim 5, wherein the substrate layer is made of plastic, and the glue layer is an organic glue.

9. The printed fabric as claimed in claim 8, wherein the fabric printed matte is an umbrella fabric, a mouse pad, or a lamp cover.
